(19) United States
(12) Patent Application Publication
(10) Pub. No.: US 2025/0033867 A1
(43) Pub. Date: Jan. 30, 2025

(54) Cannabinoid Brewing Apparatus and Process

(71) Applicant: Tanner Ezell, Phoenix, AZ (US)

(72) Inventor: Tanner Ezell, Phoenix, AZ (US)

(21) Appl. No.: 18/783,565

(22) Filed: Jul. 25, 2024

Related U.S. Application Data
(60) Provisional application No. 63/528,950, filed on Jul. 26, 2023.

(51) Int. Cl. B65D 85/804; A23F 5/46; A47J 31/06

(52) U.S. Cl. CPC B65D 85/8061; A23F 5/465; A47J 31/0668

(57) ABSTRACT

Provided is a cannabinoid brewing apparatus and process. An apparatus includes a container having a top, a filter arranged within the container, a mixture including at least one emulsifier and at least one cannabinoid arranged within the container, and a base material arranged between the filter and the top of the container.

### CROSS REFERENCE TO RELATED APPLICATION

This application claims the benefit of U.S. Provisional Patent Application No. 63/528,950, filed on Jul. 26, 2023, the disclosure of which is hereby incorporated by reference in its entirety.

### BACKGROUND

### 1. Field

This disclosure relates generally to cannabinoids and, in non-limiting embodiments, to a cannabinoid brewing apparatus and process.

### SUMMARY

According to non-limiting embodiments or aspects, provided is an apparatus comprising: a container having a top; a filter arranged within the container; a mixture comprising at least one emulsifier and at least one cannabinoid arranged within the container; and a base material arranged between the filter and the top of the container. In non-limiting embodiments or aspects, the mixture is arranged on a top side of the filter facing the top of the container. In non-limiting embodiments or aspects, the at least one emulsifier comprises at least one of the following: medium-chain triglyceride (MCT) oil, hydrogenated castor oil (HCO), tocophersolan (TPGS), or any combination thereof. In non-limiting embodiments or aspects, the base material comprises ground coffee and/or sugar. In non-limiting embodiments or aspects, further comprising a lid arranged on the top of the container.

According to non-limiting embodiments or aspects, provided is a method comprising: heating at least one emulsifier and at least one cannabinoid; homogenizing the at least one emulsifier and the at least one cannabinoid to create a mixture; and arranging the mixture in a brewing pod container. In non-limiting embodiments or aspects, the at least one emulsifier and the at least one cannabinoid are homogenized while at a temperature between 30° C. and 80° C. In non-limiting embodiments or aspects, the at least one emulsifier comprises at least one of the following: medium-chain triglyceride (MCT) oil, hydrogenated castor oil (HCO), tocophersolan (TPGS), or any combination thereof. In non-limiting embodiments or aspects, wherein arranging the mixture in the brewing pod container comprises: placing the mixture on a filter disposed inside the brewing container. In non-limiting embodiments or aspects, further comprising: placing a base material on the mixture.

According to non-limiting embodiments or aspects, provided is an apparatus comprising: a pod; a base material arranged in the pod, the base material adapted to infuse or dissolve in water; and a mixture arranged in the pod, the mixture comprising a plurality of emulsifiers and at least one cannabinoid, the mixture arranged within or adjacent to the base material, the plurality of emulsifiers comprises at least one of the following: medium-chain triglyceride (MCT) oil, hydrogenated castor oil (HCO), tocophersolan (TPGS), or any combination thereof. In non-limiting embodiments or aspects, further comprising: a filter arranged between the base material and an outlet portion of the pod. In non-limiting embodiments or aspects, the mixture is arranged on the filter. In non-limiting embodiments or aspects, the mixture comprises between a 4:1 and 20:1 ratio of emulsifiers to cannabinoids by weight.

According to non-limiting embodiments or aspects, provided is a compound comprising: medium-chain triglyceride oil; hydrogenated castor oil; tocophersolan; and a cannabis compound comprising at least one cannabinoid. In non-limiting embodiments or aspects, the medium-chain triglyceride oil, the hydrogenated castor oil, the tocophersolan, and the cannabis compound are homogenized.

### BRIEF DESCRIPTION OF THE DRAWING

Additional advantages and details are explained in greater detail below with reference to the exemplary embodiments that are illustrated in the accompanying schematic figure, in which:

FIG. 1 is a cross-sectional view of a cannabis brewing apparatus according to non-limiting embodiments.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

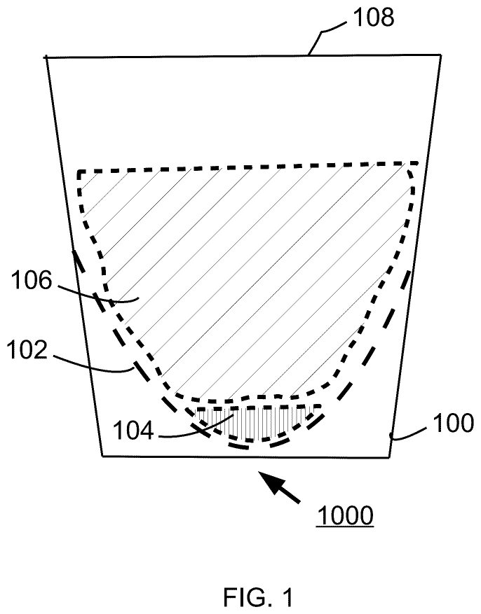

FIG. 1 illustrates a cannabinoid brewing apparatus 1000 according to non-limiting embodiments. In non-limiting embodiments, the cannabinoid brewing apparatus 1000 includes a container 100 that includes a mixture 104 of a premix material and one or more cannabinoids. In non-limiting embodiments, the mixture may be arranged on a filter 102 within the container 100. For example, the mixture 104 may be arranged on top of the filter 102 (e.g., between the filter 102 and a top opening of the container 100), on the bottom of the filter 102 (e.g., between the filter 102 and a bottom of the container 100), the mixture 104 may be partially absorbed or incorporated into the filter 102, and/or the like. In non-limiting embodiments, the mixture may be arranged on or in a base material 106, such as ground coffee, sugar, and/or other like materials that can be brewed or dissolved into water, that is arranged on the filter 102. In non-limiting embodiments the edges of the filter 102 may be adhered to and/or pressed against the interior sidewalls of the container 100 such that water introduced at the top of the container will be forced to go through the filter 102 and cannot go around the filter 102. It will be appreciated by those skilled in the art that other arrangements are possible.

In non-limiting embodiments, the mixture 104 is formed from one or more emulsifiers and one or more cannabinoids. In non-limiting embodiments, a plurality of emulsifying agents (e.g., emulsifiers) may be mixed together to form a premix material. In examples, the emulsifiers may be chosen based on solubility, stability, and/or fluidity. In a non-limiting embodiment, the premix material may be formed by substantially equal parts medium-chain triglyceride (MCT) oil, hydrogenated castor oil (HCO), and tocophersolan (TPGS). MCT oil may improve the fluidity and the resulting emulsification. HCO and TPGS may encapsulate and emulsify the cannabinoids with hot (e.g., greater than 40 C or the like) of flowing water. A combination of MCT oil, HCO, and TPGS may result in a stable non-ionic surfactant system with a hydrophilic-lipophilic balance of approximately 15.6 to facilitate the water solubility of one or more cannabinoids. Such a combination may also result in a mixture 104 that does not have an unpleasant taste. In non-limiting embodiments, one or more other emulsifiers may be used such as, but not limited to, polysorbates, SPAN® 40, SPAN® 80, ethyl lactate, and/or other emulsifiers known by those skilled in the art. It will be appreciated that other and/or different ingredients may be used to form the mixture 104 in some non-limiting embodiments, such as but not limited to other types of oils and/or emulsifiers.

The premix material may be mixed (e.g., homogenized or substantially homogenized) with one or more cannabinoids to form the mixture 104. For example, a cannabis compound may include a cannabis extract including one or more cannabinoids. In some non-limiting embodiments, the emulsifier(s) and cannabinoid(s) (e.g., cannabis compound) may each be mixed separately or at the same time. The cannabinoids may include acidic and non-acidic cannabinoids, including but not limited to cannabidiol (CBD), cannabidiolic acid (CBDa), cannabigerol (CBG), cannabigerol acid (CBGa), cannabinol (CBN), cannabidivarin (CBDV), tetrahydrocannabinol (THC), tetrahydrocannabinolic acid (THCa), tetrahydrocannabivarin (THCV), and/or the like. It will be appreciated that any cannabinoid or a combination of cannabinoids may be used in non-limiting embodiments. The premix material described herein can stabilize acidic cannabinoids (e.g., CBDa, CBGa, THCa, etc.) in a water emulsion. In non-limiting embodiments, the mixture 104 may include between 4 to 20 parts of the premix material to cannabinoids by weight (e.g., a ratio ranging from 4:1 to 20:1). However, other ratios are possible in non-limiting embodiments. The ratio of premix material to cannabinoids may be chosen based on desired particle size, where a lower ratio will result in particles of a larger size and less long-term stability of the mixture 104. The higher the ratio of premix to cannabinoids, the smaller the final product (water soluble cannabinoids) will be.

In non-limiting embodiments, the mixture 104 may be created by heating all of the emulsifier(s) and cannabinoid(s) and mixing the components while warm/hot. In non-limiting embodiments, the emulsifier(s) and cannabinoid(s) may be heated to between 30° C. and 80° C. In non-limiting embodiments, the emulsifier(s) and cannabinoid(s) may be heated to 50° C. The emulsifier(s) and cannabinoid(s) may be homogenized together with a mixing device, such as an emulsion blender or the like, while heated to the above-listed temperatures.

In non-limiting embodiments, the mixture 104 may be dosed into each container 100. For example, in non-limiting embodiments the mixture 104 may be heated to between 30° C. and 80° C. (e.g., 50° C.) to be dosed into each container 100. In non-limiting embodiments, the mixture 104 may be placed in a syringe (e.g., a repeater syringe) or other dispensing device to be dosed out in accurate amounts. In non-limiting embodiments, the mixture 104 may be dispensed onto a filter 102 (e.g., such as a paper coffee filter or any other filter device) disposed in the container 100. Capillary action may aid the mixture 104 to distribute within the filter material. In non-limiting embodiments, the mixture 104 may be dosed onto the center of the filter 102. It will be appreciated that the mixture 104 may be arranged elsewhere in the container 100, including on or in a base material (e.g., such as coffee, sugar, and/or the like), below the filter, between multiple filters, and/or the like.

In non-limiting embodiments, a base material 106 may be added on top of the dosed filter. The base material 106 may include, for example, ground coffee, sugar, and/or any other material that can be brewed or dissolved by hot water. In non-limiting embodiments, a lid 108 may be arranged and/or sealed on top of the container 100. The lid may be paper, foil, and/or the like, such that it can be pierced to provide water for brewing.

In non-limiting embodiments, the container 100 may include a disposable pod adapted to be used in a beverage brewing machine (e.g., such as a Keurig® brewing machine or any other like pod-based brewing machines). In non-limiting embodiments, the container 100 may be inserted into a brewing machine such that hot liquid (e.g., water) enters the top of the container 100 (e.g., through a puncture in the lid 108) and flows through the inside of the container and out through a puncture on the bottom of the container below the filter 102. In non-limiting embodiments, a brewing machine may pressurize the flow of water and/or air such that an internal pressure is created within the container 100 while the water is flowing through it. The pressure may be created by creating a puncture hole at the bottom of the container 100 that is small enough to let water through while still allowing water pressure to build in the container 100. In non-limiting embodiments, eight (8) ounces of liquid may be used to emulsify the mixture 104 in the liquid, although it will be appreciated that different volumes may be used. A larger volume of water may result in smaller particles.

As an example of one non-limiting embodiment, a mixture 104 may be created with 20 grams MCT oil, 20 grams TPGS, 20 grams HCO, and 3 grams of CBD, which is combined and heated at 50° C. Once at 50° C., the mixture may be homogenized with a mixing device. With such a mixture, a dose of 10 milligrams of CBD may be measured as 200 milligrams of the mixture (which will contain 10 milligrams of the CBD). However, as described here, different components, ratios, and temperatures may be used in different non-limiting embodiments.

In non-limiting embodiments, the mixture 104 may be used to coat and/or infuse coffee beans, coffee grounds, and/or other like base materials such that the coffee or other material can be brewed in a standard (e.g., non-pod) coffee brewing apparatus. In such examples, the filter used with the coffee brewing apparatus may serve as the filter 102 described above with respect to FIG. 1. The vessel of the brewing apparatus, such as a French press, drip basket, and/or the like, may serve as the container 100 described above with respect to FIG. 1. In such non-limiting embodiments, the mixture 104 may be added to coffee beans, coffee grounds, and/or other material, and mixed to evenly coat the material. In non-limiting embodiments, coffee beans may be heated before coating the beans in the mixture, and the coffee beans may be ground after such coating.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. An apparatus comprising:
a container having a top;
a filter arranged within the container;
a mixture comprising at least one emulsifier and at least one cannabinoid arranged within the container; and
a base material arranged between the filter and the top of the container.

2. The apparatus of claim 1, wherein the mixture is arranged on a top side of the filter facing the top of the container.

3. The apparatus of claim 1, wherein the at least one emulsifier comprises at least one of the following: medium-chain triglyceride (MCT) oil, hydrogenated castor oil (HCO), tocophersolan (TPGS), or any combination thereof.

4. The apparatus of claim 1, wherein the base material comprises ground coffee and/or sugar.

5. The apparatus of claim 1, further comprising a lid arranged on the top of the container.

6. A method comprising:
heating at least one emulsifier and at least one cannabinoid;
homogenizing the at least one emulsifier and the at least one cannabinoid to create a mixture; and
arranging the mixture in a brewing pod container.

7. The method of claim 6, wherein the at least one emulsifier and the at least one cannabinoid are homogenized while at a temperature between 30° C. and 80° C.

8. The method of claim 6, wherein the at least one emulsifier comprises at least one of the following: medium-chain triglyceride (MCT) oil, hydrogenated castor oil (HCO), tocophersolan (TPGS), or any combination thereof.

9. The method of claim 6, wherein arranging the mixture in the brewing pod container comprises:
placing the mixture on a filter disposed inside the brewing pod container.

10. The method of claim 9, further comprising:
placing a base material on the mixture.

11. An apparatus comprising:
a pod;
a base material arranged in the pod, the base material adapted to infuse or dissolve in water; and
a mixture arranged in the pod, the mixture comprising a plurality of emulsifiers and at least one cannabinoid, the mixture arranged within or adjacent to the base material, wherein the plurality of emulsifiers comprises at least one of the following: medium-chain triglyceride (MCT) oil, hydrogenated castor oil (HCO), tocophersolan (TPGS), or any combination thereof.

12. The apparatus of claim 11, further comprising:
a filter arranged between the base material and an outlet portion of the pod.

13. The apparatus of claim 12, wherein the mixture is arranged on the filter.

14. The apparatus of claim 11, wherein the mixture comprises between a 4:1 and 20:1 ratio of emulsifiers to cannabinoids by weight.

15. The apparatus of claim 11, wherein the mixture comprises:
medium-chain triglyceride oil;
hydrogenated castor oil;
tocophersolan; and
a cannabis compound comprising at least one cannabinoid.

16. The apparatus of claim 15, wherein the medium-chain triglyceride oil, the hydrogenated castor oil, the tocophersolan, and the cannabis compound are homogenized.
